(19) United States
(12) Patent Application Publication
(10) Pub. No.: US 2023/0066810 A1
(43) Pub. Date: Mar. 2, 2023

(54) Fan, Synchronous Machine And Methods

(71) Applicant: ABB Schweiz AG, Baden (CH)

(72) Inventors: Saeed Maleksaeedi, Waterloo, ON (CA); Göran Paulsson, Västerås (SE); Magnus Lundin, Västerås (SE); Alexandra Popovic Sandberg, Västerås (SE)

(21) Appl. No.: 17/759,749

(22) PCT Filed: Oct. 26, 2020
(86) PCT No.: PCT/EP2020/080033

§ 371 Date: Jul. 29, 2022

(30) Foreign Application Priority Data
Feb. 6, 2020 (EP) 20155822.8

(51) Int. Cl. F04D 29/34; F04D 29/32; F04D 29/64

(52) U.S. Cl. CPC F04D 29/34; F04D 29/32; F04D 29/644

(57) ABSTRACT

A fan including a hub having a central axis; a plurality of interlock blade elements connected to the hub by means of an interlock such that each interlock blade element is prevented from moving in a radial direction with respect to the hub; and an end blade element positioned on the hub between two interlock blade elements, the end blade element being fixed to the hub to prevent movement of each interlock blade element in a circumferential direction of the hub; wherein each interlock blade element is connected to the hub by a first blade movement in a radially inward direction with respect to the hub followed by a second blade movement in a circumferential direction of the hub to establish the interlock.

### TECHNICAL FIELD

The present disclosure generally relates to a fan. In particular, a fan, a synchronous machine comprising a fan, a method of producing a fan, and a method of producing a blade element for a fan, are provided.

### BACKGROUND

Synchronous machines may be cooled in order to maintain an operating temperature corresponding to a good operational efficiency. The cooling may be obtained by an air flow generated by one or more fans. To this end, some synchronous machines are provided with two axial fans, one at each end of a rotor of the synchronous machine. In this case, each fan pushes cooling air into the rotor. The air escapes from a stator of the synchronous machine and is cooled by means of a heat exchanger before returning to the fans.

Some synchronous machines are large and the size is often customized for a particular implementation. For example, some large synchronous machines have a capacity between 3 MW/MVA and 60 MW/MVA. A customized size of a synchronous machine also requires a customized size of one or more fans.

The fans for synchronous machines are typically produced by bending sheets of steel to form blades, and welding these blades to a hub made of structural steel. This manner of production is associated with several drawbacks.

The welding of the blades to the hub requires special welding skills. The skills of the welder strongly influence the quality of the welds. Moreover, the extensive manual welding adds costs. On the other hand, since synchronous machines often have a customized size, an automation of the above described manual welding process for a fan, for example by means of robotic welding, may not have any significant impact on an overall production efficiency. That is, an atomized welding process for a fan of one particular size cannot necessarily be used for a welding process for a fan of another size.

Furthermore, blades with an air foil shape have better efficiency than blades formed by bent sheets of steel. However, it is not practical to weld blades with air foil shapes to a hub.

US 2018066672 A1 discloses a modular fan assembly including a center hub assembly and a first blade attached to the center hub assembly. The center hub assembly includes a first plate and a second plate each having an outer edge and a planar capture surface. The planar capture surfaces of the second plate is arranged parallel to the planar capture surface of the first plate. The first blade includes a mounting pad and a working portion. The mounting pad has opposite, parallel planar surfaces positioned in contact with the respective planar capture surfaces of the first and second plates. The working portion extends beyond the outer edges of the first and second plates. A thickness of the first blade is smaller proximate the outer edge of the first plate than at the mounting pad to create a first gap between the first blade and the first plate at the outer edge.

US 2009/155080 A1 discloses an combination axial-flow fan comprising a fan hub and a plurality of fan blades. Each fan blade comprises a wedge block having a top protrusion for engagement into an endless mounting groove of the fan hub, and a number of positioning teeth formed on an inner side for engagement with positioning teeth of the fan hub. When the fan blades are fastened together and secured to the periphery of the fan hub, an O-shaped or C-shaped retainer ring is fastened to bottom locating grooves of the wedge blocks of the fan blades, securing the fan blades and the fan hub firmly together.

GB 860281 A discloses a fan comprising fan blades and a hub consisting of two flanges. Each fan blade comprises a root portion. By means of bolts, the root portions can be clamped between the flanges so that the fan blades can be retained in a fixed position on the hub.

U.S. Pat. No. 3,801,221 A discloses an impeller comprising a central hub and a plurality of blades. Each blade comprises a root portion. The root portions form a closed ring. The hub is made of a thermoplastic synthetic resin and is injection molded around the ring of root portions.

US 2002/127096 A1 discloses an axial ventilator having axial blades attached in a non-rotating manner. The axial ventilator is connected to a shaft.

EP 0422433 A1 discloses an arrangement for fastening turbine blades on a rotor. The rotor comprises a plurality of supporting sections on a supporting strip. Each turbine blade comprises two retaining flanges. The turbine blades are fastened to the rotor by bracketing of the flanges on both sides of the retaining flanges.

### SUMMARY

One object of the present disclosure is to provide a fan that enables a simple, fast, cost-effective and/or repeatable assembly.

A further object of the present disclosure is to provide a fan that enables a reduction of welding.

A still further object of the present disclosure is to provide a fan that solves several or all of the foregoing objects in combination.

A still further object of the present disclosure is to provide a synchronous machine solving one, several or all of the foregoing objects.

A still further object of the present disclosure is to provide a method of producing a fan, which method solves one, several or all of the foregoing objects.

A still further object of the present disclosure is to provide a method of producing a blade element for a fan, which method is simple, fast and/or cost-effective.

A still further object of the present disclosure is to provide a method of producing a blade element for a fan, which method enables a simple, fast and/or cost-effective customization of the blade element.

A still further object of the present disclosure is to provide a method of producing a blade element for a fan, which method enables an increased freedom of design.

A still further object of the present disclosure is to provide a method of producing a blade element for a fan, which method reduces a tool variation.

A still further object of the present disclosure is to provide a method of producing a blade element for a fan, which method solves one, several or all of the foregoing objects.

According to one aspect, there is provided a fan comprising a hub having a central axis; a plurality of interlock blade elements connected to the hub by means of an interlock such that each interlock blade element is prevented from moving in a radial direction with respect to the hub; and an end blade element positioned on the hub between two interlock blade elements, the end blade element being fixed to the hub to prevent movement of each interlock blade element in a circumferential direction of the hub.

Since the interlock blade elements are secured by the interlock and by the end blade element, a process of fixating the interlock blade elements to the hub can be significantly simplified. The fixing of the end blade element also fixes all the interlock blade elements. For example, in case the end blade element is fixed to the hub by means of welding, the amount of welding required can be significantly reduced. In comparison with a fan where each blade element is welded to the hub, the fan according to the present disclosure can reduce welding mass by 98%. This is because none of the interlock blade elements has to be welded to the hub.

The end blade element may be fixed to the hub by means of joining. Alternatively, or in addition, the end blade element may be fixed to the hub by means of one or more fasteners. In any case, the end blade element may be directly or indirectly fixed to the hub.

An angular extension (with respect to the central axis) of the end blade element may substantially correspond to, or correspond to, an angular extension of each interlock blade element. For example, in case the fan comprises eleven interlock blade elements and one end blade element, an angular extension of each of the interlock blade elements and the end blade element may be 30°. In any case, an angular extension of the end blade element may be less than 90°, such as less than 45°.

The fan may be an axial fan. The hub may comprise a circular opening defining the central axis. The circular opening may receive a drive shaft.

Each interlock blade element may comprise an interlock blade base portion and a blade extending from the interlock blade base portion. In this case, the interlock blade base portion may be connected to the hub by means of the interlock.

The end blade element may comprise an end blade base portion and a blade extending from the end blade base portion. In this case, the end blade base portion may be positioned on the hub between two interlock blade elements. According to one example, each blade (i.e. of the interlock blade elements and of the end blade element) has an air foil shape and/or a gradient profile.

The end blade element (e.g. the end blade base portion thereof) may be sandwiched between two interlock blade elements (e.g. the interlock blade base portions thereof). Except for these two interlock blade elements, each interlock blade elements (e.g. the interlock blade base portions thereof) may be sandwiched between two adjacent interlock blade elements (e.g. the interlock blade base portions thereof).

The fan may further comprise a locking piece and the hub may comprise an aperture. In this case, the locking piece may be seated in the aperture such that the locking piece and the end blade element form a groove, and the end blade element may be joined to the locking piece in the groove, for example by means of welding. The groove may extend between side surfaces of two adjacent interlock blade elements. These side surfaces may be secured by welding such that the interlock blade elements become fixed.

The groove may be V-shaped. That is, the V-shape may extend in the circumferential direction of the hub. The end blade element may be fixed to the hub by means of welding.

The interlock may comprise a slot and a ridge mating with the slot. The ridge may be provided on the hub and the slot may be provided in the interlock blade element (e.g. in the interlock blade base portion thereof). In this case, each of the slot and the ridge may extend in the circumferential direction of the hub. The ridge may protrude radially outwards. The slot may extend along the entire interlock blade element. The ridge may extend continuously or discontinuously around the entire hub.

Alternatively, the ridge may be provided on the interlock blade element (e.g. on the interlock blade base portion thereof) and the slot may be provided in the hub. Also in this case, each of the slot and the ridge may extend in the circumferential direction of the hub. The ridge may protrude radially inwards. The ridge may extend along the entire interlock blade element. The slot may extend continuously or discontinuously around the entire hub.

The fan may comprise a plurality of discrete interlocks, one associated with each interlock blade element. The interlocks may constitute a discrete position for each interlock blade element.

The interlock may comprise a dovetail. The dovetail may be discontinuous around at least half of a circumference of the hub (with respect to the central axis). Alternatively, or in addition, the interlock may comprise a T-shaped interlock.

Each interlock blade element may be connected to the hub by a first blade movement in a radially inward direction with respect to the hub followed by a second blade movement in a circumferential direction of the hub to establish the interlock. An angular distance of the second blade movement may be less than 3 0°, such as less than 20°, such as approximately 10°.

The end blade element may be positioned on the hub by a first end blade movement in a radially inward direction relative to the hub. The locking piece may be seated in the aperture by a locking piece movement relative to the hub substantially parallel with, or parallel with, the central axis.

The interlock may comprise a plurality of insertion structures, and each insertion structure may be arranged to receive one of the interlock blade elements in a radially inward direction with respect to the hub. This enables a plurality of interlock blade elements to be inserted into respective insertion structures at the same time, e.g. for larger fans.

The insertion structures may constitute a plurality of discrete insertion guides for the interlock blade elements during the first blade movement. One insertion structure may be provided for each interlock blade element. Optionally, one insertion structure may also be provided for the end blade element.

According to a further aspect, there is provided a synchronous machine comprising a fan according to the present disclosure.

According to a further aspect, there is provided a method of producing a fan, the method comprising providing a hub having a central axis; connecting a plurality of interlock blade elements to the hub by means of an interlock such that each interlock blade element is prevented from moving in a radial direction with respect to the hub; positioning an end blade element on the hub between two interlock blade elements; and fixing the end blade element to the hub to prevent movement of each interlock blade element in a circumferential direction of the hub. The fixing of the end blade element to the hub may be made by means of joining or by means of one or more fasteners. The fan produced by the method may be of any type according to the present disclosure.

The method may further comprise seating a locking piece in an aperture of the hub such that the locking piece and the end blade element form a groove; and securing the end blade element to the hub by joining the end blade element to the locking piece in the groove.

According to a further aspect, there is provided a method of producing an interlock blade element for a fan, the method comprising providing a sacrificial base portion; providing at least two sacrificial blades of different sizes; connecting one of the at least two sacrificial blades to the sacrificial base portion to form a sacrificial blade element; and producing a blade element based on the sacrificial blade element by means of lost-wax casting.

Since the sacrificial blade element can be formed by connecting the sacrificial base portion to either of the at least two sacrificial blades, the sacrificial blade element is modular. This modularity highly increases production efficiency and reduces costs. By means of this modularity, the method can easily be adapted to various sizes (e.g. lengths thereof) and profiles of the blade element. In addition, the tooling variation is significantly reduced.

The blade element produced by the method may be either an interlock blade element or an end blade element for the fan according to the present disclosure. Alternatively, the blade element produced by the method may be a blade element for another type of fan. The method of producing a blade element may be followed by the method of producing a fan according to the present disclosure.

The connection of the sacrificial blade to the sacrificial base portion may be made by means of glue and/or an interlock. The hub may be produced using a standard machining process known to the skilled person.

The sacrificial blades and the sacrificial base portion may be formed of wax or other material suitable for use in a lost-wax casting process. The lost-wax casting process as such may be of any suitable type known to the skilled person. The lost-wax casting process may comprise covering the sacrificial blade element with a shell, melting the sacrificial blade element, casting molten metal into the shell, breaking the shell and finishing the molded blade element.

The method may further comprise 3 D-printing the sacrificial base portion and/or the at least two sacrificial blades. The 3D-printing may be used for low production volumes. Alternatively, the method may further comprise injection molding the sacrificial base portion and/or the at least two sacrificial blades. The injection molding may be used for high production volumes.

### BRIEF DESCRIPTION OF THE DRAWINGS

Further details, advantages and aspects of the present disclosure will become apparent from the following embodiments taken in conjunction with the drawings, wherein:

FIG. 1: schematically represents a side view of a synchronous machine comprising two fans;

FIG. 2: schematically represents a perspective front view of a fan;

FIG. 3: schematically represents a perspective front view of a hub of the fan;

FIG. 4: schematically represents a front view of the hub;

FIG. 5: schematically represents a top view of the hub;

FIG. 6: schematically represents a side view of an interlock blade element of the fan;

FIG. 7: schematically represents a bottom view of the interlock blade element;

FIG. 8: schematically represents a side view of an end blade element of the fan;

FIG. 9: schematically represents a perspective front view of a locking piece of the fan;

FIG. 10: schematically represents a perspective rear view of the locking piece;

FIGS. 11-18: schematically represent steps of a method of producing the fan;

FIG. 19: schematically represents a front view of three sacrificial blades and one sacrificial base portion; and

FIG. 20: schematically represents one of the sacrificial blades connected to the sacrificial base portion.

### DETAILED DESCRIPTION

In the following, a fan, a synchronous machine comprising a fan, a method of producing a fan, and a method of producing a blade element for a fan, will be described. The same or similar reference numerals will be used to denote the same or similar structural features.

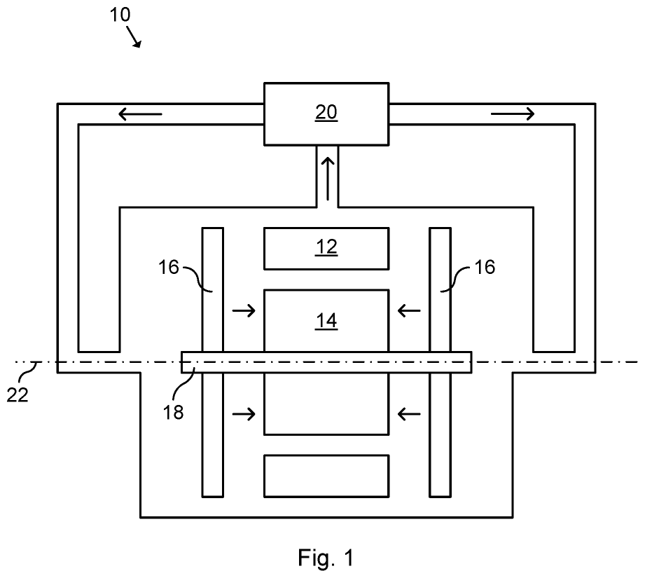

FIG. 1 schematically represents a side view of a synchronous machine 10. The synchronous machine 10 of this example comprises an electric stator 12, an electric rotor 14, two fans 16, a drive shaft 18 and a heat exchanger 20. The fans 16 and the electric rotor 14 are connected to the drive shaft 18 for common rotation about a central axis 22. The electric rotor 14 is arranged between the fans 16. Each fan 16 of this example is an axial fan. In operation, the left fan 16 generates a flow of cooling air to the right into the electric rotor 14, and the right fan 16 generates a flow of cooling air to the left into the electric rotor 14. The air escapes from the electric stator 12 and into the heat exchanger 20 for cooling the air before returning to the fans 16.

FIG. 2 schematically represents a perspective front view of one of the fans 16 in FIG. 1. The fan 16 comprises a hub 24, a plurality of interlock blade elements 26 and an end blade element 28.

The hub 24 is circular and comprises a circular opening 30 for receiving and for being driven by the drive shaft 18. The opening 30 is thus concentric with the central axis 22.

Each interlock blade element 26 is connected to the hub 24 by means of an interlock. The interlock prevents the interlock blade element 26 from moving radially (with respect to the central axis 22) relative to the hub 24. In this example, all interlock blade elements 26 have the same size and shape.

The end blade element 28 is seated on the hub 24. As shown in FIG. 1, the end blade element 28 is sandwiched, in a circumferential direction of the hub 24, between two adjacent interlock blade elements 26. The remaining interlock blade elements 26 are each sandwiched, in the circumferential direction of the hub 24, between neighboring interlock blade elements 26. A sum of an angular extension of each interlock blade element 26 and the end blade element 28 is 3 60°, or close to 360°, such as at least 350°.

The specific example of the hub 24 in FIG. 1 comprises 13 interlock blade elements 26 and one end blade element 28. Thus, eleven of the interlock blade elements 26 are sandwiched between adjacent interlock blade elements 26. In this example, each of the interlock blade elements 26 and the end blade element 28 has the same angular extension, i.e. approximately 25.7°.

The end blade element 28 is fixed to the hub 24. Since the interlock blade elements 26 are arranged around the entire circumference of the hub 24, except for the circumferential distance of the end blade element 28, the fixation of the end blade element 28 directly or indirectly (i.e. via one or more interlock blade elements 26) prevents each interlock blade element 26 from moving in the circumferential direction of the hub 24.

In the example in FIG. 2, the end blade element 28 is fixed to the hub 24 by means of welding. In this regard, the fan 16 further comprises a locking piece 32 and the hub 24 comprises an aperture 34. The aperture 34 of this example extends into the hub 24 in an axial direction from a front side of the hub 24 and in a radially inward direction from an outside of the hub 24.

The locking piece 32 of this example has an elongated shape and an angular extension corresponding to the angular extension of the end blade element 28. The locking piece 32 is seated in the aperture 34 below (or radially inwards of) the end blade element 28. The locking piece 32 and the aperture 34 are configured such that a position of the locking piece 32 is unequivocal relative to the aperture 34.

In this example, the locking piece 32 and the end blade element 28 together form a V-shaped groove 36. The V-shaped groove 36 extends uninterruptedly between the two adjacent interlock blade elements 26 in the circumferential direction of the hub 24. By welding along the V-shaped groove 36 from one interlock blade element 26 to the next interlock blade element 26 (on the other side of the locking piece 32), the end blade element 28 and the locking piece 32 are fixed to the hub 24.

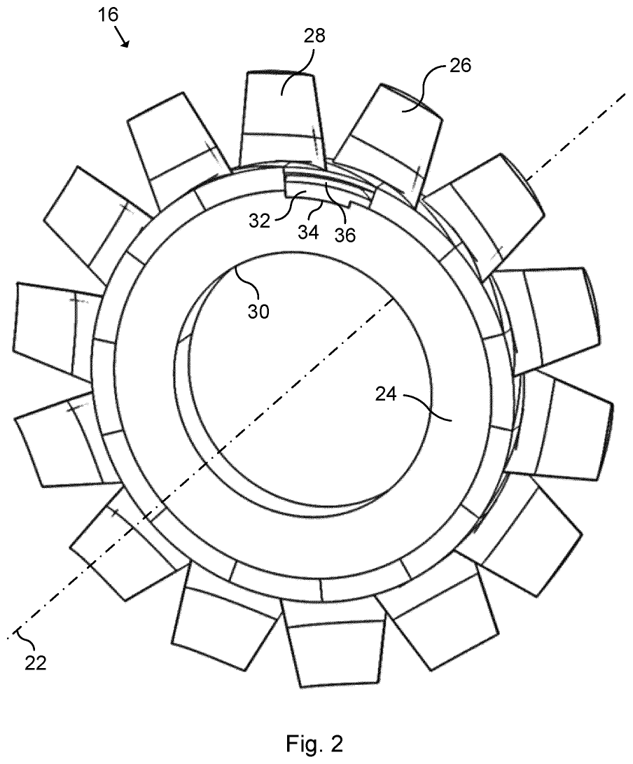

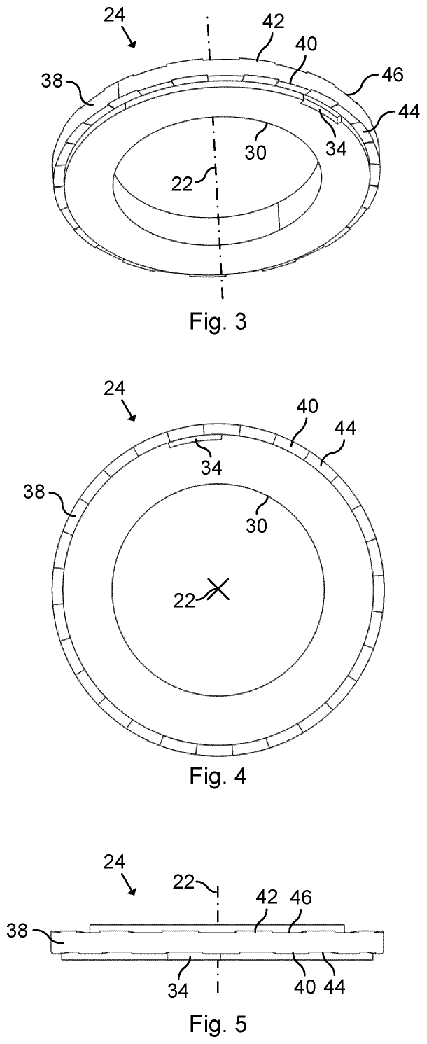

FIG. 3 schematically represents a perspective front view of the hub 24, FIG. 4 schematically represents a front view of the hub 24, and FIG. 5 schematically represents a top view of the hub 24. With collective reference to FIGS. 3-5, the hub 24 comprises a ridge 38. The ridge 38 protrudes radially outwards and extends continuously around the entire circumference of the hub 24.

The hub 24 further comprises a plurality of front features, here exemplified as front wedges 40, and a plurality of rear features, here exemplified as rear wedges 42. The front wedges 40 are provided on a front side of the ridge 38 and the rear wedges 42 are provided on a rear side of the ridge 38. Each front wedge 40 is inclined towards the central axis 22 in front of the hub 24. Each rear wedge 42 is inclined towards the central axis 22 behind the hub 24. The front wedges 40 are thus angled forwardly and the rear wedges 42 are angled rearwardly.

The hub 24 further comprises a plurality of front insertion structures, here exemplified as front flat portions 44, and a plurality of rear insertion structures, here exemplified as rear flat portions 46. The front flat portions 44 are provided on the front side of the ridge 38, and the rear flat portions 46 are provided on the rear side of the ridge 38. Each of the front flat portions 44 and the rear flat portions 46 are perpendicular to the central axis 22.

The front wedges 40 and the front flat portions 44 are alternatingly provided around the front side of the ridge 38. The rear wedges 42 and the rear flat portions 46 are alternatingly provided around the rear side of the ridge 38. As particularly shown in FIG. 5, the front wedges 40 and the rear wedges 42 are offset. That is, each front wedge 40 is aligned with (along the circumferential direction) a rear flat portion 46, and each rear wedge 42 is aligned with a front flat portion 44.

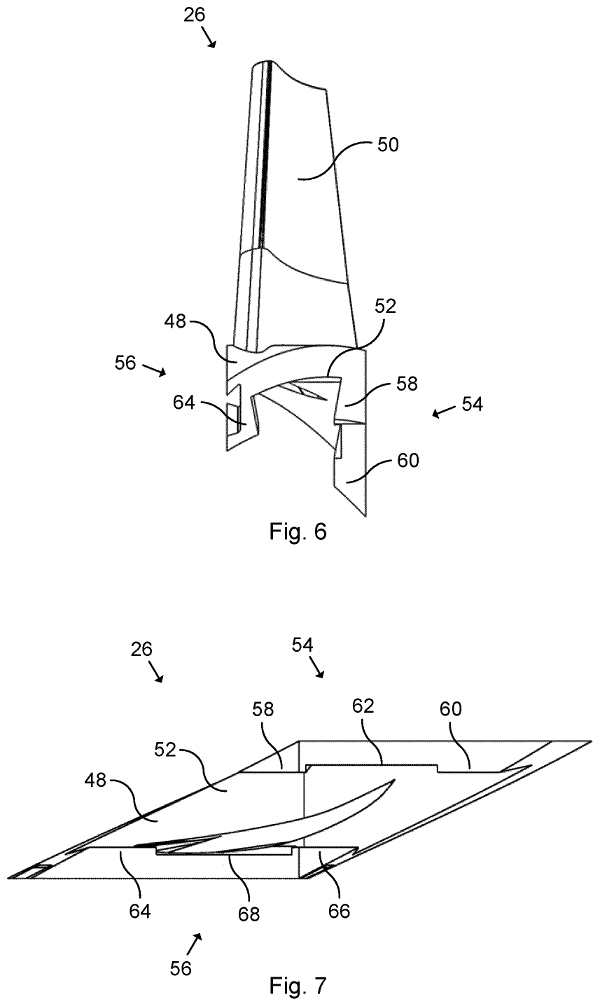

FIG. 6 schematically represents a side view of one of the interlock blade elements 26, and FIG. 7 schematically represents a bottom view of the interlock blade element 26 in FIG. 6. With collective reference to FIGS. 6 and 7, the interlock blade element 26 comprises an interlock blade base portion 48 and a blade 50 extending from the interlock blade base portion 48.

The interlock blade element 26 further comprises a slot 52. In this example, the slot 52 is provided in the interlock blade base portion 48. When mounted to the hub 24, the slot 52 extends in the circumferential direction of the hub 24. The interlock blade element 26 is configured to receive the ridge 38 in the slot 52.

The interlock blade base portion 48 comprises a front blade engaging structure 54 and a rear blade engaging structure 56. The front blade engaging structure 54 and the rear blade engaging structure 56 are configured to enable the interlock blade element 26 to be moved radially inwards onto the ridge 38 such that the ridge 38 is received in the slot 52, and subsequently rotated about the central axis 22 along the ridge 38 such that the interlock blade element 26 interlocks to the hub 24 to prevent radial movement of the interlock blade element 26.

In this specific example, the front blade engaging structure 54 comprises a first front blade pin 58, a second front blade pin 60, and a front blade flat portion 62 between the first front blade pin 58 and the second front blade pin 60. The rear blade engaging structure 56 comprises a first rear blade pin 64, a second rear blade pin 66, and a rear blade flat portion 68 between the first rear blade pin 64 and the second rear blade pin 66. Each of the first front blade pin 58 and the second front blade pin 60 has an angle corresponding to an angle of each front wedge 40, and each of the first rear blade pin 64 and the second rear blade pin 66 has an angle corresponding to an angle of each rear wedge 42.

As shown in FIG. 7, the front blade engaging structure 54 and the rear blade engaging structure 56 are offset. Thus, the first front blade pin 58 faces the rear blade flat portion 68, and the second rear blade pin 66 faces the front blade flat portion 62.

With collective reference to FIGS. 2-7, the interlock blade element 26 can be moved radially inwards towards the hub 24 such that each of the first front blade pin 58 and the second front blade pin 60 passes along a front flat portion 44 between two front wedges 40, the front blade flat portion 62 passes over a front wedge 40, each of the first rear blade pin 64 and the second rear blade pin 66 passes along a rear flat portion 46 between two rear wedges 42, and the rear flat portion 46 passes over a rear wedge 42. The ridge 38 is then received in the slot 52. Thus, two front flat portions 44 and two rear flat portions 46 constitute one example of an insertion structure.

The interlock blade element 26 can then be rotated in the circumferential direction of the hub 24 until each of the first front blade pin 58 and the second front blade pin 60 is aligned with a respective front wedge 40, and each of the first rear blade pin 64 and the second rear blade pin 66 is aligned with a respective rear wedge 42. In this state, the interlock blade element 26 is interlocked to the hub 24 such that the interlock blade element 26 is prevented from moving in a radial direction with respect to the hub 24.

The interlock between the slot 52 and the ridge 38 of this example comprises a dovetail. The front wedges 40 and the rear wedges 42 form tails of the dovetail and the first front blade pin 58, the second front blade pin 60, the first rear blade pin 64 and the second rear blade pin 66 form pins of the dovetail.

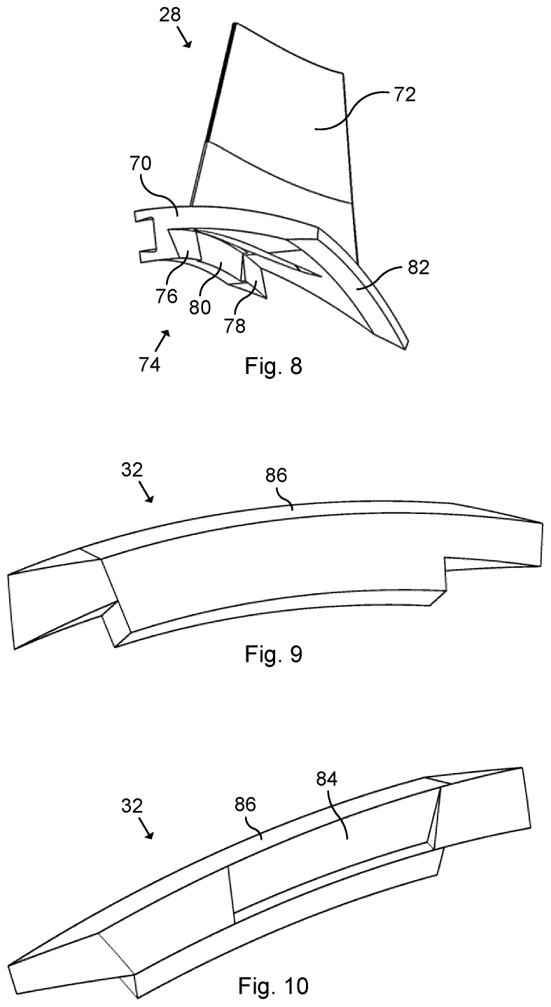

FIG. 8 schematically represents a side view of the end blade element 28. The end blade element 28 comprises an end blade base portion 70 and a blade 72 extending from the end blade base portion 70. The end blade element 28 comprises a rear end blade engaging structure 74. The rear end blade engaging structure 74 is provided in the end blade base portion 70.

The rear end blade engaging structure 74 comprises a first rear end blade pin 76, a second rear end blade pin 78, and a rear end blade aperture 80 arranged between the first rear end blade pin 76 and the second rear end blade pin 78. The rear end blade engaging structure 74 is thus of the same design as the rear blade engaging structure 56 of the interlock blade element 26. The end blade base portion 70 further comprises an end blade groove surface 82.

FIG. 9 schematically represents a perspective front view of the locking piece 32, and FIG. 10 schematically represents a perspective rear view of the locking piece 32. With collective reference to FIGS. 9 and 10, the locking piece 32 is elongated and curved in the circumferential direction of the hub 24 (when seated in the aperture 34).

The locking piece 32 comprises a locking piece aperture 84. The locking piece aperture 84 is configured to mate with a front wedge 40 on the ridge 38.

The locking piece 32 further comprises a locking piece groove surface 86. The locking piece groove surface 86 and the end blade groove surface 82 form the V-shaped groove 36.

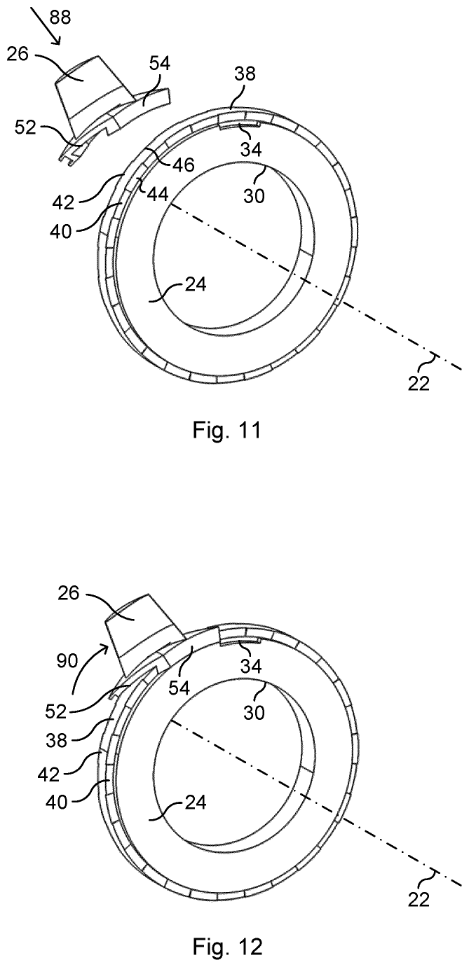

FIGS. 11-18 schematically represent steps of a method of producing the fan 16. As shown in FIG. 11, a first interlock blade element 26 is moved to the hub 24 by a first blade movement 88 in the radially inward direction with respect to the hub 24. The first blade movement 88 proceeds until the ridge 38 is entirely received in the slot 52. During the first blade movement 88, the first front blade pin 58 and the second front blade pin 60 are aligned with respective front flat portions 44, and the first rear blade pin 64 and the second rear blade pin 66 are aligned with respective rear flat portions 46. In this way, the ridge 38 provides a plurality of discrete insertion guides for the interlock blade element 26 during the first blade movement 88.

FIG. 12 shows the interlock blade element 26 after a second blade movement 90 in the circumferential direction of the hub 24. The second blade movement 90 is a rotation of the interlock blade element 26 in the circumferential direction of the hub 24, i.e. along a circle centered on the central axis 22. After the second blade movement 90, the interlock blade element 26 is connected to the hub 24 by means of an interlock such that the interlock blade element 26 is prevented from moving in the radial direction with respect to the hub 24. In this example, the angular distance of the second blade movement 90 is approximately 12°. The mechanical interlock is thus established by rotating the interlock blade element 26 along the ridge 38 about the central axis 22.

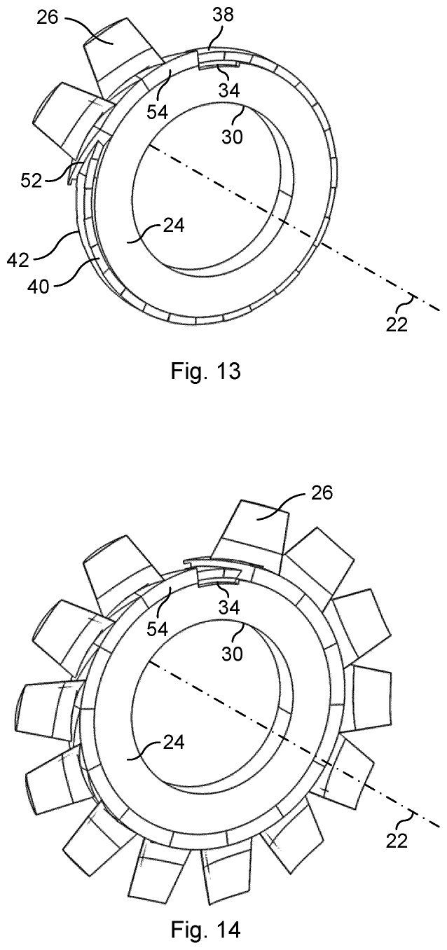

As shown in FIG. 13, a further interlock blade element 26 is then connected to the hub 24 in the same way as in FIGS. 11 and 12. As can be gathered from FIG. 13, a plurality of interlock blade elements 26 can be connected to the hub 24 at the same time. In FIG. 14, all interlock blade elements 26 have been connected to the hub 24.

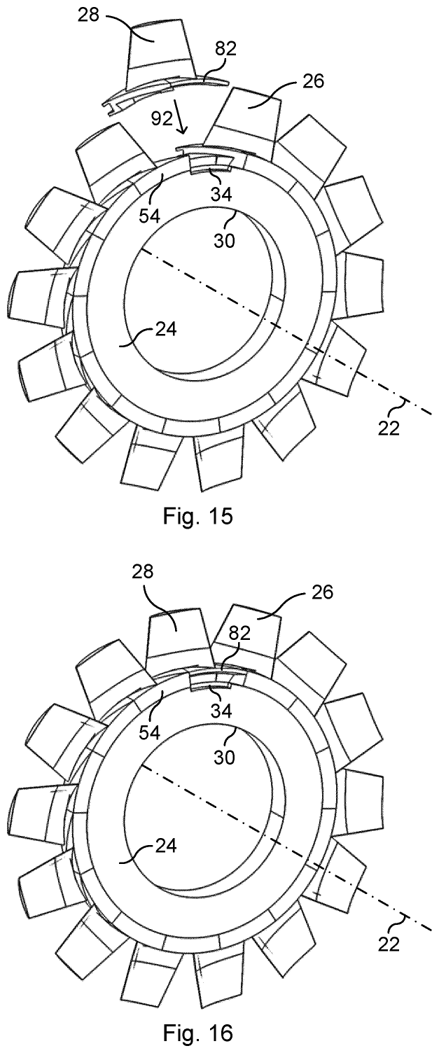

As shown in FIG. 15, the end blade element 28 is moved to the hub 24 by an end blade movement 92 in the radially inward direction with respect to the hub 24. The end blade movement 92 proceeds until the end blade base portion 70 is seated on the ridge 38. During the end blade movement 92, the first rear end blade pin 76 and the second rear end blade pin 78 are aligned with respective rear flat portions 46. In this way, the ridge 38 also provides a discrete insertion guide for the end blade element 28 during the end blade movement 92.

FIG. 16 shows the positioning of the end blade element 28 after the end blade movement 92. In FIG. 16, the end blade base portion 70 is positioned on the hub 24 and sandwiched between two interlock blade base portions 48.

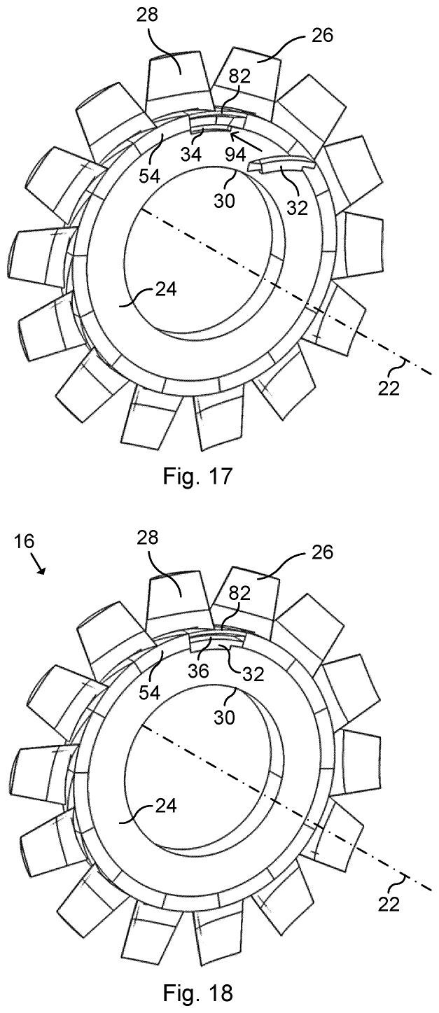

FIG. 17 shows how the locking piece 32 is moved to the hub 24 by a locking piece movement 94. The locking piece movement 94 is parallel with the central axis 22.

FIG. 18 shows how the locking piece 32 is seated in the aperture 34 after the locking piece movement 94 and forms the V-groove 36 together with the end blade groove surface 82 of the end blade element 28. The end blade element 28 is then secured to the hub 24 by welding along the V-groove 36 from the left adjacent interlock blade element 26 to the right adjacent interlock blade element 26. Once the end blade element 28 is secured to the hub 24, all interlock blade elements 26 are prevented from moving in the circumferential direction and are thereby also secured to the hub 24.

In the following, a method of producing a blade element 26, 28 for a fan 16 will be described. The method may be used to produce either the end blade element 28, one or several interlock blade elements 26 or combinations thereof.

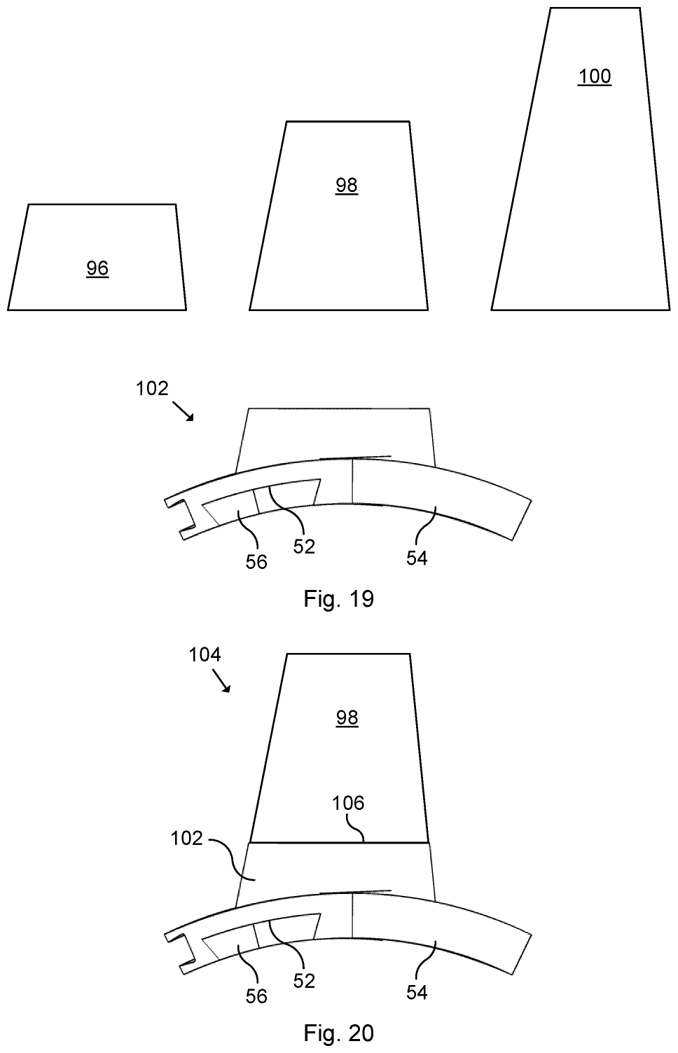

FIG. 19 schematically represents a front view of three sacrificial blades 96, 98 and 100 and one sacrificial base portion 102. The first sacrificial blade 96 is smaller than the second sacrificial blade 98 and the third sacrificial blade 100 is larger than the second sacrificial blade 98. In this example, the sacrificial base portion 102 is molded in wax and each of the sacrificial blades 96, 98 and 100 are 3 D-printed in wax.

The sacrificial base portion 102 can be produced in standard sizes. In this example, the size and shape of the sacrificial base portion 102 correspond to the size and shape of the interlock blade base portion 48. Thus, similarly to the interlock blade base portion 48, the sacrificial base portion 102 comprises a slot 52, a front blade engaging structure 54 and a rear blade engaging structure 56. The size and shape of the second sacrificial blade 98 correspond to the size and shape of the blade 50.

FIG. 20 schematically represents the second sacrificial blades 98 connected to the sacrificial base portion 102 to form a sacrificial blade element 104. The sacrificial blade element 104 is thus modular which is associated with several advantages. The connection is made by means of glue along a joint 106. The selection of the second sacrificial blade 98 among the sacrificial blades 96, 98 and 100 is made based on a size requirement of the fan 16 and/or based on a cooling requirement of the synchronous machine 10.

A blade element 26, 28 is then produced based on the sacrificial blade element 104 by means of lost-wax casting. Thus, the sacrificial blade element 104 is covered with a shell. The sacrificial blade element 104 is then melted. Molten metal is then casted into the shell. The shell is then broken and the molded blade element 26, 28 is polished.

Once a plurality of interlock blade elements 26 have been produced in this way, the end blade element 28 may then be produced in the same way. The interlock blade elements 26 and the end blade element 28 can then assembled to the hub 24 as described in FIGS. 11-18.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A fan comprising:
a hub having a central axis;
a plurality of interlock blade elements connected to the hub by means of an interlock such that each interlock blade element is prevented from moving in a radial direction with respect to the hub; and
an end blade element positioned on the hub between two interlock blade elements, the end blade element being fixed to the hub to prevent movement of each interlock blade element in a circumferential direction of the hub;
wherein each interlock blade element is connected to the hub by a first blade movement in a radially inward direction with respect to the hub followed by a second blade movement in a circumferential direction of the hub to establish the interlock;
wherein the
fan further comprises a locking piece;
wherein the huh comprises an aperture;
wherein the Socking piece is seated in the aperture such that the locking piece and the end blade element form a groove;
wherein the end blade element is joined to the locking piece in the groove; and wherein the groove extends between side surfaces of two adjacent interlock blade elements.

2. (canceled)

3. The fan according to claim 1, wherein the groove is V-shaped.

4. The fan according to claim 1, wherein the end blade element is fixed to the hub by means of welding.

5. The fan according to claim 1, wherein the interlock comprises a slot and a ridge mating with the slot.

6. The fan according to claim 1, wherein the interlock comprises a dovetail.

7. The fan according to claim 6, wherein the dovetail is discontinuous around at least half of a circumference of the hub.

8. The fan according to claim 1, wherein the interlock comprises a plurality of insertion structures, and wherein each insertion structure is arranged to receive one of the interlock blade elements in a radially inward direction with respect to the hub.

9. The fan according to claim 8, wherein one insertion structure is provided for each interlock blade element.

10. A synchronous machine comprising a fan having:
a hub having a central axis;
a plurality of interlock blade elements connected to the hub by means of an interlock such that each interlock blade element is prevented from moving in a radial direction with respect to the hub; and
an end blade element positioned on the hub between two interlock blade elements, the end blade element being fixed to the hub to prevent movement of each interlock blade element in a circumferential direction of the hub;
wherein each interlock blade element is connected to the hub by a first blade movement m a radially inward direction with respect to the hub followed by a second blade movement in a circumferential direction of the hub to establish the interlock;
wherein the fan further comprises a locking piece;
wherein the hub comprises an aperture;
wherein the locking piece is seated in the aperture such that the locking piece and the end blade element form a groove;
wherein the end blade element is joined to the locking piece in the groove; and wherein the groove extends between side surfaces of two adjacent interlock blade elements.

11. A method of producing a fan, the method comprising:
providing a hub having a central axis;
connecting a plurality of interlock blade elements to the hub by means of an interlock such that each interlock blade element is prevented from moving in a radial direction with respect to the hub, wherein each interlock blade element is connected to the hub by a first blade movement in a radially inward direction with respect to the hub followed by a second blade movement in a circumferential direction of the hub to establish the interlock;
positioning an end blade element on the hub between two interlock blade elements; and
fixing the end blade element to the hub to prevent movement of each interlock blade element in a circumferential direction of the hub;
seating a locking piece in an aperture of the hub such that the locking piece and the end blade element form a groove, the groove extending between side surfaces of two adjacent interlock blade elements; and
securing the end blade element to the hub by joining the end blade element to the locking piece in the groove.

12. (canceled)
